(19) United States
(12) Patent Application Publication
(10) Pub. No.: US 2011/0244746 A1
(43) Pub. Date: Oct. 6, 2011

(54) SYNTHETIC LEATHER FABRIC WITH LYOCELL BACKING AND METHOD OF PRODUCING THE SAME

(75) Inventor: J. Michael Dobin, Pompano Beach, FL (US)

(73) Assignee: VALLEY FORGE FABRICS, INC., Pompano Beach, FL (US)

(21) Appl. No.: 13/078,365

(22) Filed: Apr. 1, 2011

Related U.S. Application Data
(60) Provisional application No. 61/320,358, filed on Apr. 2, 2010.

(51) Int. Cl. B32B 5/02; B29C 53/04; B32B 37/00; B29C 53/38

(52) U.S. Cl. 442/181; 428/221; 442/304; 442/327; 156/60; 156/218

(57) ABSTRACT

A fabric includes a synthetic leather and a substrate containing Lyocell. The substrate backs and adheres to the synthetic leather. A method for producing a fabric includes providing a substrate containing Lyocell and adhering a synthetic leather to the substrate containing Lyocell. The synthetic leather may be formed of polyurethane or polyvinyl chloride.

### CROSS-REFERENCE TO RELATED APPLICATION

This application claims the priority under 35 U.S.C. 119(e) of U.S. Provisional Patent Application No. 61/320,358, filed Apr. 2, 2010.

### BACKGROUND OF THE INVENTION

1. Field of the Invention

The invention relates to a synthetic leather fabric with a Lyocell backing. Synthetic leathers include polyurethane (PU) and polyvinyl chloride (PVC). Lyocell is a generic fiber name and is defined by the FTC (U.S. Federal Trade Commission) as a cellulose fiber obtained by an organic solvent spinning process where:

1)“Organic solvent” means a mixture of organic chemicals and water, and

2)“solvent spinning” means dissolving and spinning without the formation of a derivative.

2. Description of the Related Art

U.S. Pat. No. 7,150,055 discloses a multi-layered bedclothes material in which four layers, including a cotton sheeting, a poly or polycotton sheeting, a polyester or polyester acrylic fill and a cotton or polycotton cloth fabric, are shown in FIG. 7 and quilting is shown in FIG. 8 thereof.

U.S. Pat. Nos. 5,925,581 and 5,806,154 respectively disclose a textile laminate and a method of making a textile laminate, in which a quilted fabric 37 shown in FIG. 6 is made up of several layers, including an outer layer of quilt, a face layer, second fibers of polypropylene, a fiber fill web substrate and an outer layer of quilt, are shown in FIG. 5.

U.S. Pat. No. 3,801,420 shows a plastic quilted bedspread having a sandwich of a top vinyl layer, a padding layer of Dacron or urethane foam and a third interfacing layer, as well as a bottom layer of nylon, with a binding or beading at the edges.

Several disclosures in the prior art, such as U.S. Patent Application Publication Nos. US 2007/0004302; US 2007/0105469 and US 2008/0090076, International Publication No. WO 2008/019412 and Japanese Patent Publication No. JP 10-53934 mention the use of Lyocell as filler material. U.S. Pat. No. 7,067,444 relates to the use of Lyocell for a nonwoven fabric. Other disclosures, such as International Publication Nos. WO 03/099047 and 03/078720, U.S. Patent Application Publication Nos. US 2004/0176008; US 2005/0095936 and 2005/0118919 and Japanese Patent Publication No. JP-10-18145 mentioned the use of Lyocell for clothing, linings, mattress covers and ticking. Finally, several other disclosures mention the use of Lyocell for wall coverings or furniture, such as U.S. Patent Application Publication Nos. US 2008/0299854; 2008/0299854; 2008/0096001; 2007/0248819; 2005/0227558; 2007/0082574; 2009/0004474 and 2008/0085651 as well as U.S. Pat. Nos. 7,326,664; 7,225,487 and 7,150,059 and International Publication No. WO 2009/059342 A1, but as a non-woven fabric.

Clothing and sheeting do not require the same abrasion, seam and heavy duty wear testing that a synthetic leather would for upholstery, wall paneling and other end uses for which Applicant markets fabrics. Thus, Lyocell has been used in the past in sheeting, filled products, and in clothing applications, but not for synthetic leather.

### BRIEF SUMMARY OF THE INVENTION

It is accordingly an object of the invention to provide a synthetic leather fabric with a Lyocell backing and a method of producing the same, which overcome the hereinafore-mentioned disadvantages of the heretofore-known products and methods of this general type and which meet or exceed the rigorous durability requirements of the commercial and hospitality industry while providing the desired product face.

With the foregoing and other objects in view there is provided, in accordance with the invention, a fabric, comprising a synthetic leather and a substrate containing Lyocell, in which the substrate backs and adheres to the synthetic leather. This fabric provides the desired face of the product and meets or exceeds the rigorous durability requirements of the commercial and hospitality industry.

In accordance with another feature of the invention, the synthetic leather includes at least one material selected from the group consisting of polyurethane and polyvinyl chloride. Polyurethane and polyvinyl chloride are able to provide the fabric with the desired face.

In accordance with a further feature of the invention, the synthetic leather has the following content: 100% polyvinyl chloride, 98% polyvinyl chloride and 2% polyurethane top coating, 100% polyurethane, or 50% polyvinyl chloride and 50% polyurethane mixture.

In accordance with an added feature of the invention, the substrate containing Lyocell has the following content: 100% Lyocell, a blend of Lyocell and polyester, a blend of Lyocell and rayon, or a blend of Lyocell and cotton. Lyocell provides the desired strength and durability of the synthetic leather fabric.

In accordance with an additional feature of the invention, the substrate containing Lyocell has a non-woven construction, a woven construction, or a knitted construction.

In accordance with yet another feature of the invention, the fabric has a content of approximately 68% by weight polyvinyl chloride, approximately 2% by weight polyurethane and approximately 30% by weight Lyocell.

In accordance with yet a further feature of the invention, the fabric has a content of approximately 60% by weight polyurethane and approximately 40% by weight Lyocell.

With the objects of the invention in view, there is also provided a method for producing a fabric. The method comprises providing a substrate containing Lyocell and adhering a synthetic leather to the substrate containing Lyocell. As mentioned above, the fabric according to the invention provides the desired face of the product and meets or exceeds the rigorous durability requirements of the commercial and hospitality industry.

In accordance with another mode of the invention, the method includes selecting the synthetic leather from the group consisting of polyurethane and polyvinyl chloride. Polyurethane and polyvinyl chloride are materials which provide the face of the product which is desired, when applied by using the method according to the invention.

In accordance with a further mode of the invention, the method includes selecting the synthetic leather as 100% polyvinyl chloride, 98% polyvinyl chloride and 2% polyurethane top coating, 100% polyurethane, or 50% polyvinyl chloride and 50% polyurethane mixture.

In accordance with an added mode of the invention, the method includes selecting the content of the substrate containing Lyocell as 100% Lyocell, a blend of Lyocell and polyester, a blend of Lyocell and rayon, or a blend of Lyocell and cotton. Lyocell provides the desired strength and durability of the synthetic leather fabric.

In accordance with an additional mode of the invention, the method includes selecting a non-woven construction, a woven construction, or a knitted construction of the substrate containing Lyocell.

In accordance with yet another mode of the invention, the method includes providing the fabric with a content of approximately 68% polyvinyl chloride, approximately 2% polyurethane and approximately 30% Lyocell.

In accordance with yet a further mode of the invention, the method includes providing the fabric with a content of approximately 60% polyurethane and approximately 40% Lyocell.

In accordance with an added mode of the invention, the method includes rolling dyed polyurethane over the substrate containing Lyocell or a Lyocell blend in two separate layers, spreading a release paper having a pattern over the polyurethane while wet, drying the release paper, pulling the dry release paper from the polyurethane surface leaving a product with a surface effect or pattern, rolling the product onto cardboard tubes, and cutting the product to roll lengths ranging from 10 yards to 45 yards. The rolls are then packed on pallets for shipping. The Polyurethane chemical comes in barrels and is dyed in various colors for each production run.

In accordance with a concomitant mode of the invention, the method includes rolling dyed polyvinyl chloride onto the substrate containing Lyocell or a Lyocell blend in two or three separate layers depending on a final product to be produced, after the final layer, running an engraved metal roller over the wet polyvinyl chloride, leaving a product with a surface effect or pattern, drying the product, rolling the product onto cardboard tubes, and cutting the product to roll lengths ranging from 10 to 50 yards. The rolls are then packed on pallets for shipping. The PVC chemical comes in barrels and is dyed in various colors for each production run.

Applicant has therefore developed synthetic leathers that are formed of either 100% polyurethane, 100% PVC, or combinations of both polyurethane and PVC with a Lyocell substrate. These products will meet or exceed the above-mentioned rigorous durability requirements of the commercial and hospitality industry. Traditional PVC and polyurethanes are made with rayon, cotton, or polyester substrates.

Applicant is using various constructions, designs, colors, and patterns with Lyocell and Lyocell blend substrate synthetic leather fabric.

Applicant has a litany of testing requirements for a product to meet industry standards, which are listed below. Although the technical requirements are listed below, before a product meets these requirements, there are basic requirements to which a product must adhere:
A synthetic leather cannot scratch easily under use;
A synthetic leather cannot wrinkle excessively in handling, shipping, or upholstering;
Color matching must stay consistent;
Technical testing must remain consistent from one production lot to the next; and
Pattern matching must remain consistent from one lot to the next.

The substrate backing causes changes to the face of the product. Trial production with each new substrate fabric blend must be performed to establish an acceptable face. As important, new color samples must be made of every color to ensure color continuity since color dying formulas will need to be adjusted with the new substrate.

A new development for a substrate material is a difficult process since the substrate can affect the surface properties of the face and of the entire product. Color variation is a high possibility, loss of color and lightfast properties is a possibility, as well as seam and tear problems, amongst other issues. Lyocell has never been experimented with as a backing or substrate for a synthetic leather, and basic as well as technical tests listed below all come into play. Finding a formulation that can still meet or exceed testing while using a Lyocell or Lyocell blend backing is important.

Technical testing requirements that synthetic leathers in high traffic areas are required to meet are listed below:
ASTM D4157 Abrasion resistance (Double Rub Test)—Minimum of 30,000 double rubs to be considered heavy duty.
ASTM D3884-01 Abrasion Resistance of Textile Fabrics (Rotary Platform, Double Head Method (Taber Test))—5,000 cycles for heavy duty.
ASTM D4034 and D3597 Seam Slippage Test—ACT standards call for a minimum of 25 pounds in warp and weft, Applicant has a self-imposed minimum of 35 pounds in warp and weft for this test.
ASTM D5362 Bean Bag Snag Test.
ASTM D3511 Brush Pill—Minimum of 3.0.
AATCCC 8 Wet and Dry Crocking test—Dry crock must meet a minimum of 4.0. Dry Crocking must meet a minimum of 3.5.
AATCC 16H Colorfastness to light—Must meet a minimum of 40 hours at grade 4.0.
ASTM D2261 Tongue Tear Test—Minimum of 8 pounds.
ASTM D5034-95 Tensile Strength/Breaking strength test—Minimum 35 pounds.
FR code of California bulletin 117 section E must be met or exceeded.
Fr code of UFAC NFPA 260 must be met or exceeded.
CFFA 17 Expansion Percentage 15 pound stretch—15% warp and 25% fill.

Other features which are considered as characteristic for the invention are set forth in the appended claims.

Although the invention is illustrated and described herein as embodied in a synthetic leather fabric with a Lyocell backing and a method of producing the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

Applicant has produced durable synthetic leathers for multiple uses including, but not limited to, upholstery, wall paneling, cushions, hotel furniture, residential furniture, automotive, and office furniture.

The heavy duty synthetic leathers according to the invention are made by using a range including, but not limited to:
100% PVC.
98% PVC with 2% PU top coating.
100% Polurethane (PU).
50% PVC and 50% PU mixture.

The backing content covers a range including but not limited to:
100% Lyocell.
A blend of Lyocell and polyester.
A blend of Lyocell and rayon.
A blend of Lyocell and cotton.

The backing construction covers a range including but not limited to:
Non-woven construction.
Woven construction.
Knitted Construction.

The backing, also known as the substrate, is made in 5,000 yard put ups on rolls that range but are not limited to 250 to 800 yards. This substrate is made in either a light color or a dark color. The dark color substrate is used for dark colors of synthetic leather. The light color substrate is used for light colors of synthetic leather.

The substrate is placed on rollers in Applicant's PU (polyurethane) and PVC (polyvinyl chloride) manufacturing platform, and the PU and/or PVC is adhered to the substrate.

The Polyurethane chemical comes in barrels and is dyed in various colors for each production run. The PU process includes release papers where the dyed Polyurethane is rolled over the Lyocell or Lyocell blend substrate in 2 separate layers. Paper is then spread over the polyurethane while wet. The paper is known as a release paper, and this paper has a pattern to it. Once dry, the paper is pulled from the polyurethane surface leaving a surface effect, or pattern. The product is then rolled onto cardboard tubes, cut to roll lengths ranging from 10 yards to 45 yards. Rolls are then packed on pallets for shipping.

The PVC chemical comes in barrels and is dyed in various colors for each production run. The PVC process includes metal rollers. The dyed PVC is rolled onto the Lyocell or Lyocell blend substrate in 2 or 3 separate layers depending on the product. After the final layer, an engraved metal roller is run over the wet PVC, leaving an effect or pattern. Once dry, the product continues through the machine and is rolled onto cardboard tubes and cut to roll lengths ranging from 10 to 50 yards. Rolls are then packed on pallets for shipping.

The final content of the product is determined by percentage weight of the PU or PVC area versus the weight of the Lyocell or Lyocell blend substrate. Initial products range but are not limited to:
68% PVC, 2% PU, 30% Lyocell.
60% PU, 40% Lyocell.

1. A fabric, comprising:
a synthetic leather; and
a substrate containing Lyocell, said substrate backing and adhering to said synthetic leather.

2. The fabric according to claim 1, wherein said synthetic leather includes at least one material selected from the group consisting of polyurethane and polyvinyl chloride.

3. The fabric according to claim 1, wherein said synthetic leather is selected from the group consisting of:
100% polyvinyl chloride;
98% polyvinyl chloride and 2% polyurethane top coating;
100% polyurethane; and
50% polyvinyl chloride and 50% polyurethane mixture.

4. The fabric according to claim 1, wherein said substrate containing Lyocell has a content selected from the group consisting of:
100% Lyocell;
a blend of Lyocell and polyester;
a blend of Lyocell and rayon; and
a blend of Lyocell and cotton.

5. The fabric according to claim 1, wherein said substrate containing Lyocell has a construction selected from the group consisting of:
a non-woven construction;
a woven construction; and
a knitted construction.

6. The fabric according to claim 1, wherein the fabric has a content of approximately 68% by weight polyvinyl chloride, approximately 2% by weight polyurethane and approximately 30% by weight Lyocell.

7. The fabric according to claim 1, wherein the fabric has a content of approximately 60% by weight polyurethane and approximately 40% by weight Lyocell.

8. A method for producing a fabric, the method comprising the following steps:
providing a substrate containing Lyocell; and
adhering a synthetic leather to the substrate containing Lyocell.

9. The method according to claim 8, which further comprises selecting the synthetic leather from the group consisting of polyurethane and polyvinyl chloride.

10. The method according to claim 8, which further comprises selecting the synthetic leather from the group consisting of:
100% polyvinyl chloride;
98% polyvinyl chloride and 2% polyurethane top coating;
100% polyurethane; and
50% polyvinyl chloride and 50% polyurethane mixture.

11. The method according to claim 8, which further comprises selecting a content of the substrate containing Lyocell from the group consisting of:
100% Lyocell;
a blend of Lyocell and polyester;
a blend of Lyocell and rayon; and
a blend of Lyocell and cotton.

12. The method according to claim 8, which further comprises selecting a construction of the substrate containing Lyocell from the group consisting of:
a non-woven construction;
a woven construction; and
a knitted construction.

13. The method according to claim 8, which further comprises providing the fabric with a content of approximately 68% by weight polyvinyl chloride, approximately 2% by weight polyurethane and approximately 30% by weight Lyocell.

14. The method according to claim 8, which further comprises providing the fabric with a content of approximately 60% by weight polyurethane and approximately 40% by weight Lyocell.

15. The method according to claim 8, which further comprises:
rolling dyed polyurethane over the substrate containing Lyocell or a Lyocell blend in two separate layers;
then spreading a release paper having a pattern over the polyurethane while wet;
then drying the release paper;
then pulling the dry release paper from the polyurethane surface leaving a product with a surface effect or pattern;
then rolling the product onto cardboard tubes; and
then cutting the product to roll lengths.

16. The method according to claim 8, which further comprises:
rolling dyed polyvinyl chloride onto the substrate containing Lyocell or a Lyocell blend in two or three separate layers depending on a final product to be produced;
after the final layer, running an engraved metal roller over the wet polyvinyl chloride, leaving a product with a surface effect or pattern;
then drying the product;
then rolling the product onto cardboard tubes; and
then cutting the product to roll lengths.
